(19) United States
(12) Patent Application Publication
(10) Pub. No.: US 2022/0061508 A1
(43) Pub. Date: Mar. 3, 2022

(54) One Time Use Harness System for Body Worn Smart Phone

(71) Applicants: Chris Randall Scheffler, Concord, CA (US); Olivia Ann Scheffler, Concord, CA (US)

(72) Inventors: Chris Randall Scheffler, Concord, CA (US); Olivia Ann Scheffler, Concord, CA (US)

(21) Appl. No.: 17/003,993

(22) Filed: Aug. 27, 2020

(51) Int. Cl. A45F 5/00; F16M 13/04

(52) U.S. Cl. CPC A45F 5/00; F16M 13/04; A45F 2200/0533; A45F 2005/006; A45F 2200/0516

(57) ABSTRACT

A disposable, one-time use, recyclable, smart phone harness for allowing handfree use of the smart phone's camera for live video streaming. The inventive device includes body having a rear projection for angling the top of smart phone away from a wearer's torso, a rubber strap for securing the smart phone to the inventive device, and an attached cord for securing the inventive device around the wearer's neck.

### BACKGROUND OF THE INVENTION

### 1. Field of Invention

This invention relates to mechanisms for securing devices such as a camera strap, and more specifically, to an improved harness system for attaching a device such as video enabled smart phone to a human for use while walking such as during a facility survey.

### 2. Description of the Related Arts

Building inspectors, appraisers, engineers and similar occupations require on-site visits to survey conditions at various facilities. Remote video streaming or telepresence may allow such surveys without on-site visits, however, holding a video streaming camera device (such as a smart phone) in one hand is impractical for long periods. Body-worn camera harnesses are available (U.S. Pat. No. 4,396,137 Benjamin; U.S. Pat. No. 4,168,022 Brewer), but these are complex and not conducive to a one-time use, disposable, recyclable application. Currently, streaming of video handsfree requires investment in a device dedicated to this purpose or investment in a harness designed to hold a video streaming multi-purpose device such as a smart phone. If a body worn smart phone harness were available that is simple and adaptable to a variety smart phones, then the inspector could perform the survey via telepresence, by sending the harness to the facility to be surveyed, instructing an on-site individual to attach their personal smart phone device to the harness, initiating a video call, and instructing the on-site individual to tour the facility while the inspector views the tour remotely. Furthermore, if the harness positions the smart phone's camera to be outward facing, and on the upper body, to avoid obstructed views, it could obtain a view similar to that of the on-site individual. Additionally, if the harness is inexpensive, small, light weight, adaptable to a variety of shapes and sizes of smart phone devices, and constructed of environmentally sustainable materials, then the inspector could conduct multiple surveys per day or per week, by sending out harnesses to numerous facilities, with little concern for whether these harness get returned or damaged. With this combination of features in a harness, these remote surveys would become practical.

### SUMMARY OF THE INVENTION

A disposable, one-time use, recyclable, smart phone harness for allowing handfree use of a smart phone's camera for live video streaming. Hence, the present invention beneficially allows the user hands free operation of the video streaming capabilities of the smart phone device while walking and taking notes, for example, then disposing and recycling of the smart phone harness.

The inventive device is a harness for securing a smart phone to a user's body, (e.g. upper torso), in a manner allowing for the smart phone camera to be aimed in various directions to obtain a point of view similar to that of the wearer when forward looking while walking. The inventive device includes a body to support a user's smart phone, an attached elastic strap for securing a smart phone to the body of the inventive device, and an attached cord for securing the inventive device with attached smart phone around the wearer's neck. The body of the device has a rear projection for angling the top of a smart phone away from a wearer's torso such that the smart phone camera has view similar to that of the wearer.

It is to be understood that the application of the invention is not limited to the construction details and to componen arrangements described or illustrated herein. Other embodiments are possible. The choice of phrases and terms used herein are for descriptive purposes and should not be regarded as limiting.

The primary object of the present invention is to overcome the shortcomings of the prior art devices.

A second objective of the invention is to provide a harness of a cost which makes it economical to dispose of the harness after a single use.

Another object is to provide a smart phone harness that is of a simple construction, using low cost readily commercially available materials, including but not limited to recycled and/or recyclable materials. In one embodiment, the structural components of the harness would be constructed with including but not limited to, e.g., polyethelyne teraphthalate (PET), card board, and corrugated paper, with the cord components made with including but not limited to, e.g., polyester or paper cord.

Another object is to provide a smart phone harness that is small and light weight and adjustable so that it can be worn by users of all sizes.

Another object is to provide a smart phone harness that may be configured to adapt to, fit and secure a wide variety of smart phones ranging in shape, size and type.

Another object is to provide a smart phone harness that is beneficially simple to ship, and is adaptable for use by a variety of users.

Another object is to provide a smart phone harness that positions the smart phone's camera to be outward facing, and as high on the wearer's body as practical, such near shoulder height.

Another object is to provide a smart phone harness that provides unobstructed views and obtaining a view moderately similar to that of the wearer.

Another object is to provide a smart phone harness that is inexpensive to manufacture, making it economical and environmentally responsible to dispose of the harness after a single use.

Another object is to provide a smart phone harness that enables inspectors and similar users to perform property surveys via telepresence.

Other objects and advantages of the present invention will become obvious to the reader and it is intended that these objects and advantages are within the scope of the present invention.

### BRIEF DESCRIPTION OF THE DRAWINGS

FIG. 1 is a front view of the present invention in an unfolded position, revealing its parts in full view.

FIG. 2 is three perspective views of the present invention in a folded position.

FIG. 3 is a front view of the present invention with an attached exemplary smart phone and being worn by a user.

FIG. 4 is a side view of the present invention with an attached exemplary smart phone and being worn by a user.

### DESCRIPTION OF THE PREFERRED EMBODIMENT

The present invention is a simple, low cost, light weight, easy to use, recyclable, one-time-use disposable harness for securing a smart phone or similar video streaming or recording device on a person's upper torso to enable hands free telepresence. Additionally, the harness is adaptable to a variety of shapes and sizes of smart phone devices, easy to use and adaptable to many shapes and sizes of human users. Hence, new users can master the device quickly with minimal instruction. Additionally, the device is designed to be light weight, small and economical for one-time-use and disposable, and constructed of environmentally sustainable and recycled and/or recyclable materials. Hence the device can be shipped to new users, used once, then disposed of. In one embodiment, the device would have an on-board power supply to ensure the on-site individual's smart phone has adequate battery life for the duration of the survey. With these features, the device enables property inspectors, appraisers, engineers and other person engaged in property surveys to conduct such surveys remotely via telepresence, with little concern for whether the harness gets returned or damaged.

The harness has a main structural body, made from a flat material, to which is attached a cord for securing the harness around the wearer's body, which can be best understood by referring to the figures herein.

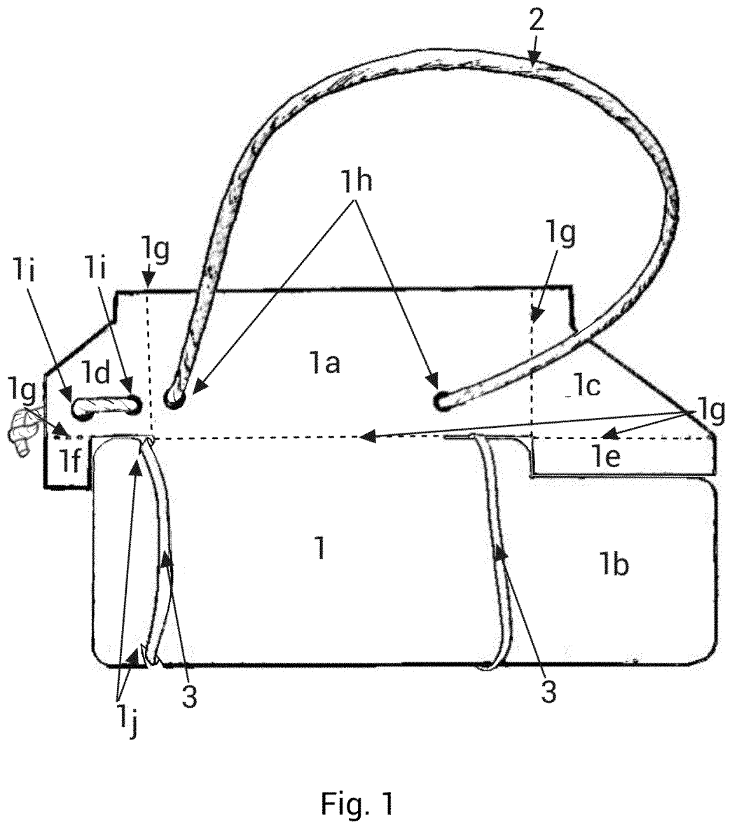

FIG. 1 is a view of the harness (1) in an unfolded position, revealing its parts in full view. The structural body of harness (1) is made up of a single piece of flat material shaped into a rectangular main section with a projection (1a) extending from the top, and other features (1b-1h) described here: The projection, when folded and adhered or attached to the back of the body (1) supports the body of the harness away from the wearer's torso (not shown), thus positioning the body of the invention vertically, thus orienting an attached smart phone (not shown) to be forward facing with respect to the wearer. Perforations (1g), indentations or other means defining a fold line (1g) in the projection and supporting braces (1c and 1d). Tabs (1e and 1f) or similar means at the distant end of the supporting braces (1c and 1d) for attaching or adhering the distant end of the supporting braces to the back of the body. Slots (1h), holes or fasteners for securing the flexible cord (2) to the body. Slots (1i) are sized for friction fit of cord (2) such that the cord does not slide in the slot, until the wearer deliberately adjusts the cord by pulling on the cord, thus allowing the wearer (not shown) to adjust harness for comfort and a secure fit. The cord (2) attaches to the body of the harness and wraps around the wearer's neck and torso to secure the harness to the wearer. Attachment of cord 2 to body 1 is accomplished by any suitable means of securing a cord to a flat material, including but not limited to tying, sewing, gluing, stapling, and so on. Elastic bands (3), at each end of the structural body, secure the smart phone to the structural body of the harness.

In one embodiment, a flag (1b) extends from the body of the device to enable wording (for example, “NOTICE—Live Video Stream in Progress”), signage or symbols to be written on, drawn on, or afixed to the invention.

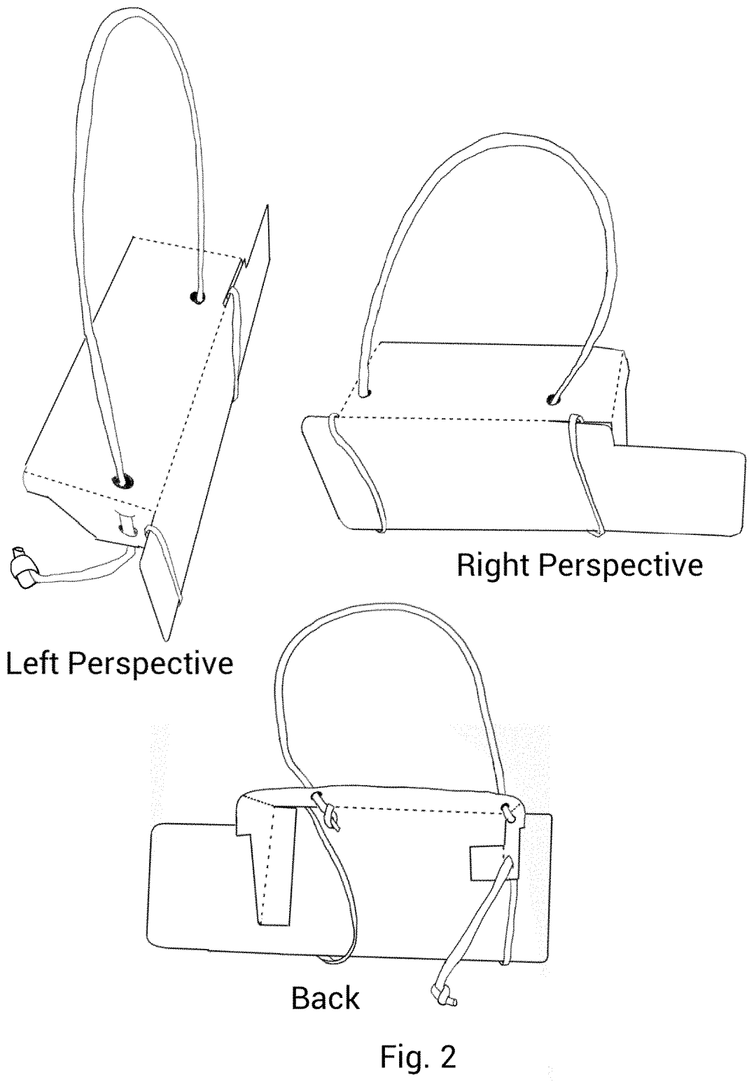

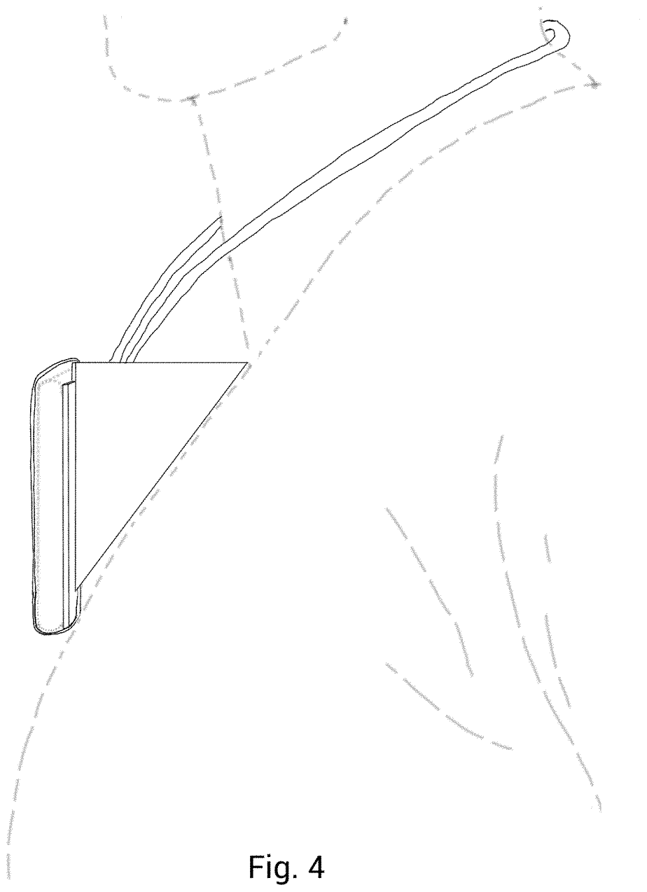

FIG. 2 is three perspective views of the harness in a folded position, revealing how the projection (1a) folds toward the back of the body (1) to allow the tabs (1e and 1f) to attach to the back of the body (1) to form the invention into a triangle. It is this triangular shape that supports the body of the harness away from the wearer's torso (see FIG. 4), thus positioning the body of the invention vertically, thus orienting the front of an attached smart phone (not shown) in a plane somewhat parallel to the front of the wearer (not shown). Knots (2a) or similar means secure the cord to the projection (1a).

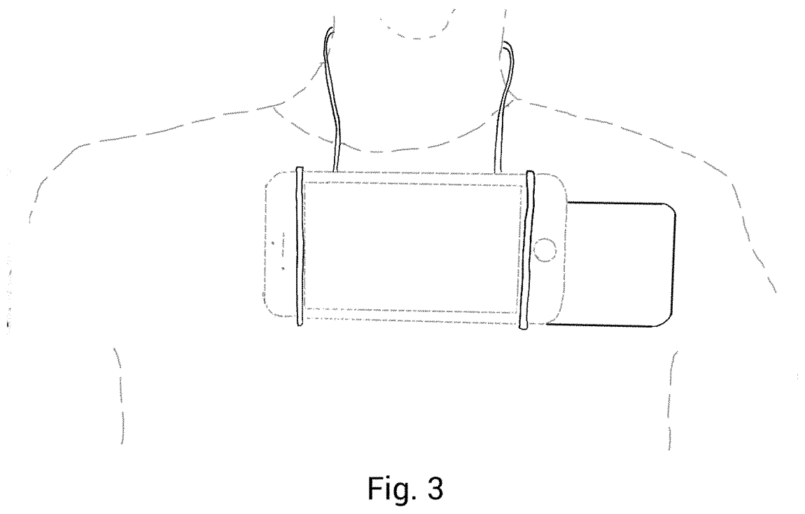

Use of the harness can best be understood by referring to FIG. 3. To use the invention, the wearer secures their personal smart phone to the structural body of the harness by inserting the two ends of their smart phone under the two elastic bands (3), being careful to not block the front camera. The smart phone is positioned such that the back of the smart phone is against the harness body (1), and the smart phone's front camera faces out away from the harness body. The cord (2) is positioned around the wearer's neck. The wearer secures the cord comfortably on the torso by pulling on the cord (2b) as needed.

In one embodiment, a flag (1b) is extended from the body of the device to enable wording (for example, “NOTICE—Live Video Stream in Progress”), signage or symbols to be written, drawn or afixed to the device.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equilvalents may be resorted to, falling within the scope of the invention.

We claim:

1. A harness system for a video enabled device, comprising:
a flat body having a top and a bottom and a front and a back and a left end and a right end; and
a projection from the back of said flat body near the top of said flat body; and
a flexible cord having a fixed end and an adjustable end, wherein both ends of said flexible cord is attached near the top of said flat body; and
a band or bands attached to the front of said flat body.

2. The harness system of claim 1, wherein the size and proportions of said body are within the range of the several most common video enabled smart phone devices.

3. The harness system of claim 1, wherein said projection is of such a length as to position the front of said flat body into a vertical orientation when said projection is positioned against a wearer's upper torso.

4. The harness system of claim 1, wherein said flat body and said projection are constructed of a single piece of flat material shaped into the said flat body and said projection.

5. The harness system of claim 1, wherein the junction of said flat body with said projection is of a flexible material and/or is creased, indented or perforated allowing said projection to be folded flat against the back of said flat body.

6. The harness system of claim 1, wherein the fixed end of said flexible cord is secured to said projection or to one of these positions on said flat body: to the top or left end or right end or front or back.

7. The harness system of claim 6, wherein a slot and/or hole and/or slots and/or holes is/are present in said flat body in a position different from the position where the fixed end of said flexible cord is secured.

8. The harness system of claim 7, wherein said slot and/or hole and/or slots and/or holes is/are sized for a friction fit when said flexible cord is inserted into said slot and/or hole and/or slots and/or holes.

9. The harness system of claim 8, wherein the adjustable end of said flexible cord is inserted into said slot and/or hole and/or slots and/or holes.

10. The harness system of claim 1, wherein said flexible cord is of a length sufficient to wrap around the neck of a large human wearer plus sufficient additional length to permit the wearer to adjust the elevation of a video enabled device attached to said flat body from approximately the bottom of the wearer's sternum to approximately the top of the wearer's sternum.

11. The harness system of claim 1, wherein said band or bands are elastic or rubber and are sized to securely grip one of the several most common video enabled smart phone devices.

12. The harness system of claim 1, wherein the materials of construction are recyclable with the exception of the band or bands.
